(19) United States
(12) Patent Application Publication
(10) Pub. No.: US 2002/0124188 A1
(43) Pub. Date: Sep. 5, 2002

(54) Computing environment for facilitating collaboration between professional service providers and their clients

(75) Inventors: Mark D. Sherman, Minneapolis, MN (US); Tom Sherman, Minneapolis, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Vipadvisor.com, Inc., Minneapolis, MN

(21) Appl. No.: 10/081,738

(22) Filed: Feb. 20, 2002

Related U.S. Application Data
(60) Provisional application No. 60/270,104, filed on Feb. 20, 2001.

(51) Int. Cl. G06F 15/173; H04L 9/32; G06F 17/60

(52) U.S. Cl. 713/201; 709/223; 705/35

(57) ABSTRACT

A system for facilitating collaboration has a database in network communication with a server. Relationships between users on the network are defined individually as to pairs of users. Each relationship is unique to the user pair and does not extend to other users. The relationships define networks or teams of users, which cross traditional corporate and network boundaries to link up people who otherwise cannot get connected. Users have user accounts within a database, which stores relationship information for user pairs. Each relationship is unique relative to each pair of users, and users may have more than one relationship. Web based productivity tools provide enhancements to the user environment so that pairs of users can collaborate over the system using the tools according to the established relationships.

### CROSS-REFERENCE TO RELATED APPLICATION(S)

The present invention claims priority from provisional patent application serial No. 60/270,104 filed on Feb. 20, 2001 entitled “COLLABORATIVE COMPUTING ENVIRONMENT FOR PROFESSIONAL SERVICE PROVIDERS.”

### FIELD OF THE INVENTION

The present invention relates to collaborative computing environments between service providers and their clientele, and more particularly, to a collaborative computing environment for assembling dynamic teams users who share relationships with one another.

### BACKGROUND OF THE INVENTION

In the 1990's, many companies built computer networks to help their employees communicate with each other. Generally, such networks provided a secure environment for colleagues on the network to exchange information, to share documents, and to communicate electronically. The resulting efficiencies have been responsible for dramatic leaps in business productivity.

In the real world, most people work every day with others located outside their own corporate networks. While technology theoretically brings the “paperless office” within reach, the reason the paperless office has not happened is because most companies do not conduct business with themselves, and their corporate network does not extend to their customers. Communicating with others outside of the corporate network usually means picking up the telephone and leaving messages. Electronic mail (e-mail) works well for setting lunch dates or for saying “hello.” However, e-mail is not secure, and many organizations need to be able to exchange confidential information with individuals outside of the corporate network. Thus, working with others has typically meant leaving such network efficiencies behind. To send documents outside of the corporate network, people resort to delivering documents by facsimile, standard or express mail, and/or courier.

Some software developers have attempted to address such privacy and security concerns by introducing special software programs, which allow for real-time or near real-time document collaboration over the Internet. However, such software solutions typically require both users to have a particular software program installed on their respective computers. Compatibility between programs and between different versions of the same program present barriers to collaboration. Furthermore, to collaborate using such software, typically both users must be available at the same time to share the document. Finally, in many cases, the required software simply is not available for computers running Linux, Unix, the Macintosh OS, and the like, and is not available for personal digital assistants.

Existing network solutions typically group users together, in essence, assuming a relationship between all members of the network. Such a relationship may not exist. In fact, grouping clients together and treating them all as if they were the same is precisely the type of behavior most companies try to avoid, because such grouping neglects the various needs of the individual clients. Moreover, such one-size-fits-all solutions may group individuals who do not wish to be associated. Unfortunately, neither the existing software nor the existing network solutions address both the needs and the concerns of professional service providers.

A network solution is needed that extends the efficiencies of the corporate network to individuals who are outside of the corporate network. The network solution should allow sharing of information securely between an individual within an organization and a client outside of the organization, without letting the client or other clients know about the business relationship and without exposing confidential information. Moreover, to fully exploit such efficiencies, the network solution must be based on real-world relationships so that the users are organized in the system in groups that make sense in the real world. Finally, the network solution must recognize that each client has different needs and different technological capabilities, so the solution must work on any type of machine and over any type of Internet connection (especially slow or wireless connections). There is a need for a distributed, cross-platform, dynamic, Internet-based, relationship-centric, collaboration environment for facilitating team work across geographic, physical and virtual boundaries.

### BRIEF SUMMARY OF THE INVENTION

The present invention has a database and a server, and uses Internet technology to extend the benefits of the corporate network to corporate clients and their advisors, without compromising the security and efficiency of the existing corporate network. Rather than the network defining the relationships between users, the present invention allows the relationships between users to determine the network. The system allows users to be connected regardless of where or for whom they work. The server provides an interface for facilitating collaboration between service providers and their clients, and provides a suite of web-based tools that make the process of collaborating on-line easier. The server allows service providers and clients to share documents and exchange information securely, outside of the service provider's network. The system provides tools for document sharing and secure electronic mail, using standard software and built-in security protocols that are already installed on most computers. Finally, the system allows each organization to administer their own users on the system using administration tools from within a web browser.

### BRIEF DESCRIPTION OF THE DRAWINGS

FIG. 1 is a block diagram of the physical structure of the system of the present invention.

FIG. 2 is a schematic flow diagram of the user account set up within the present invention.

FIG. 3 is a schematic block diagram of the interrelationships between users in the present invention.

FIG. 4 is a schematic block diagram of a different interrelationship configuration within the system of the present invention.

FIG. 5 is a schematic block diagram of a network of teams in the present invention.

FIG. 6 is a schematic block diagram of an office/client configuration of the present invention.

FIG. 7 is a schematic flow diagram of a user logging into the system of the present invention.

FIG. 8 is a schematic flow diagram of the document sharing process of the present invention.

While the above-identified illustrations set forth preferred embodiments, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION

Conceptually, the present invention extends a traditional, secure, computer network within an organization to include clients and/or advisors from different networks, from different organizations, on different machines and from varying geographic locations. Specifically, the present invention allows users to exchange confidential information, send e-mail, generate task lists, and so on, across corporate and geographic boundaries through secure connections over a distributed network, such as the Internet.

Within the system, each user has a user account. Users are related within the system to define teams for collaboration. Relationships between users on a team are defined on an individual basis, such that each pair of users has a defined relationship. Each relationship establishes a hierarchy between two users: such as advisor/client, advisor/advisor, and so on. The individual relationships define loose-knit, overlapping teams of users to facilitate collaboration. Each team is made up of a client and one or more advisors, and each relationship between the client and each advisor on the team is defined individually. By organizing the system according to user relationships, in essence, the network is defined by individual relationships. Instead of a single network with many users, the system defines multiple user-centric networks or teams, which parallel real-world networks of people.

### 1. Hardware

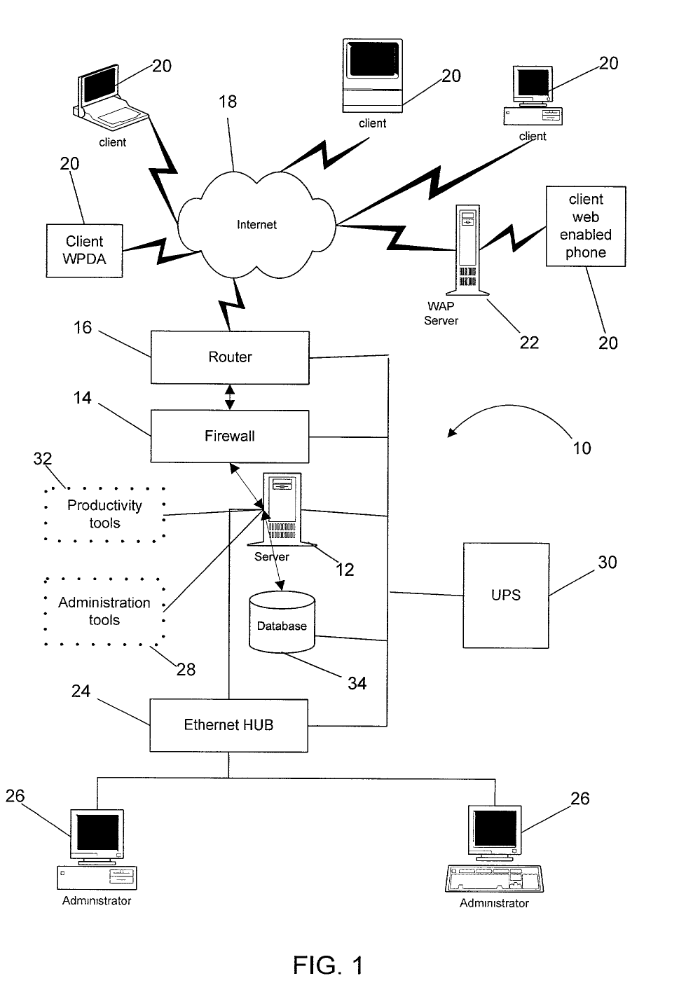

First, to facilitate the discussion, the hardware is introduced to show one possible embodiment of the physical hardware of the invention. As shown in FIG. 1, the system 10 consists of a web server/data warehouse 12 (“web server”), which is connected via a network to a firewall 14. The firewall 14 is connected via a router 16 to the Internet 18. Authorized users 20 access records or files stored in a relational database on the web server 12 through a secure connection over the Internet 18. Authorized users 20 are users who have registered accounts with the system 10. Authorized users 20 can access the system 10 using any web-enabled device, including desktop or laptop computers, personal digital assistants (such as the PalmPilot™, and the like), web-enabled cellular and/or digital telephones (which may require a wireless access protocol server 22 to access the Internet 18), and other web-enabled devices. Generally, “web enabled device” means any device capable of browsing the Internet using Internet browser.

The web server 12 is connected to an Ethernet hub 24, which connects the web server 12 to other internal systems and allows internal administrators 26 to access the web server 12 using web-based administration tools 28. An uninterruptible power supply 30 (UPS) protects the web server 12, the firewall 14, the router 16 and the Ethernet hub 24 from power supply problems. Finally, the collaboration system 10 includes productivity tools 32, which are modules that supplement the user account with professional enhancements for facilitating interactions between service providers and their client, such as between a doctor and a patient, a lawyer and a client, a financial advisor and an investor, and so on.

In the preferred embodiment, the web server 12 is a secure server. In the present context, “secure server” refers to a server that is registered with a digital certificate authority for the purpose of authenticating the server and of providing secure transactions over the Internet.

The administration tools 28 are active server web pages that are hosted by the web server 12 as web-based tools, so that administrators can access and administer the system 10 from any location and from any Internet-enabled device with a web browser. The administration tools 28 are provided through a web page interface, which provides hypertext buttons or links to numerous customization and maintenance utilities. The administrators 26 use the administration tools 28 to set up and configure user accounts, to assign relationships between pairs of users 20, administer the database, and so on. Additionally, the administration tools 28 allow the host to review account statistics, such as the last time the person visited the account, the duration of that visit and so on. The administration tools 28 are available to administrators 26 on the internal network and to remote administrators using secure socket layers (SSL). Both the administrators 26 on the internal network and remote administrators access the administration tools 28 through a web browser over the Internet 18.

Similarly, the productivity tools 32 are active server pages hosted by the web server 12. Since the productivity tools 32 operate in conjunction with the database, and since the user 20 accesses the system 10 through a web browser, productivity tools 32 are made available simply by clicking on a hypertext link within the user's main page. New functional modules can be added to the system 10 and additional productivity tools 32 can be added by adding new hypertext links while the tools are being used, making the functionality of the new module immediately available to that user 20 upon refresh of the user's Internet browser window.

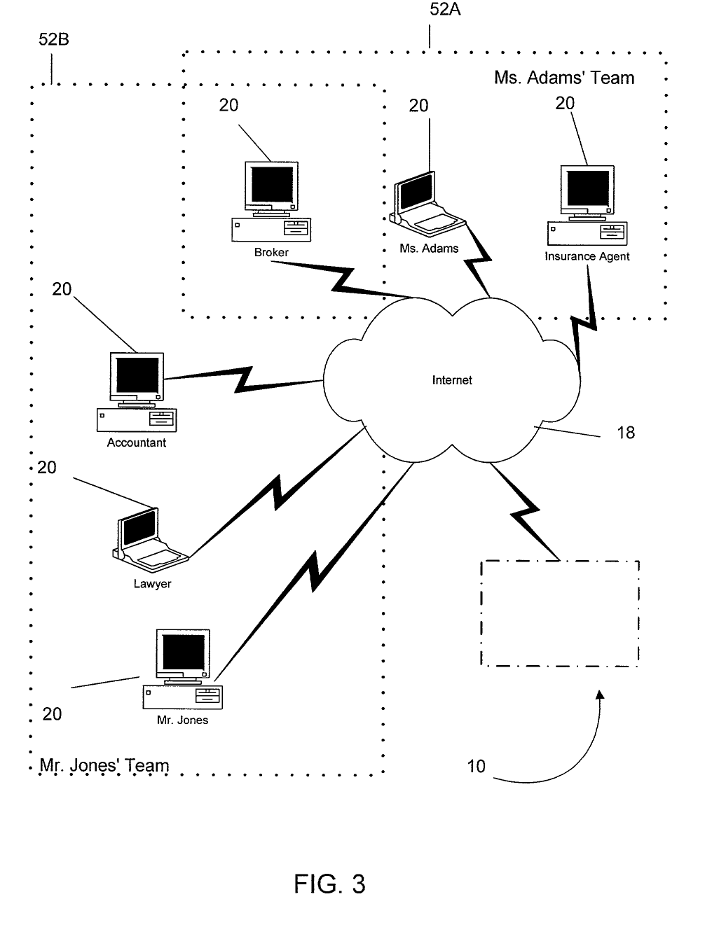

Generally, the productivity tools 32 add functionality to the user account. Such productivity modules 32 include a “documents” module, an accounts module, a messages module, a task list module, and so on. For example, at a basic level, the system 10 serves as a virtual file cabinet. An authorized user 20 (i.e. a user 20 with a user ID and password) is permitted to store digital files, such as documents, images, sounds, movies or video clips, and the like, in his or her virtual file. The stored documents are then retrievable by the user 20 from any computer, simply by logging onto the system over the Internet 18. Once a document is uploaded, the individual user 20 who posted the document may choose to share a document or account information with another user 20; however, sharing a document requires a relationship between the user 20 and the user with whom the document is to be shared. This functionality will be discussed in greater detail with respect to FIGS. 3-6.

The web server 12 provides a web site interface and back end database warehousing for storing, retrieving and displaying information dynamically on the Internet. For simplicity, the web server 12 is shown to contain both the Internet server and data warehousing capabilities; however, the web server 12 may be configured to provide only the web site interface, and a database server (not shown) may be used to host the database and perform the data warehousing. Furthermore, an application server (not shown) may be provided to host the productivity tools 32, separate from the web server 12.

The hardware used to perform the present invention may vary from implementation to implementation. Specific database architectures and hardware elements may change over time as technologies improve; however, the essential workings of the relationship-based, Internet-enabled system 10 remain the same, regardless of the specific hardware used.

While the system 10 has been described with respect to a single server 12, it may be desirable to maintain separate servers 12 having different security levels and different modular capabilities. Server 12 traffic volume may be adjusted by using additional mirror servers 12 and distributing users 20 among the various servers 12. Such a division of network traffic is anticipated as the user 20 traffic grows, so that servers 12 can be serviced and maintained without significant interruption of services.

### 2. The Collaboration System

The hardware described above with respect to FIG. 1 is one embodiment of hardware for implementing a collaborative system that extends the efficiencies of a corporate network to the exchange of information between distributed users, who for a variety of reasons should be maintained as separate users, such as clients of a law firm and the like. These efficiencies of the corporate network typically include network security, file sharing, e-mail, task lists, and so on.

As previously mentioned, the present invention allows users to collaborate over the Internet, or over any network (such as a corporate Intranet for a particularly large corporation having numerous servers to facilitate collaboration across departments). Users are associated within the system 10 according to relationships, and the relationships essentially define networks of users, such that the network itself is ultimately defined by the relationships.

Generally, relationships are hierarchical within the system, allowing for grouping of relationships. While currently, the system 10 uses two main categories (“advisor” and “client”), other categories may be added or may supplant these terms, depending on the environment in which the invention is used. For example, in a doctor clinic, suitable categories may include “doctor”, “nurse”, and “patient.” For the purpose of the following discussion and to clarify the operation of the system 10, the present invention will be described with respect to Financial Advisory Company, a fictitious financial advising organization, which sponsors financial advisors and which has many clients.

### 2a. Setup and Administration

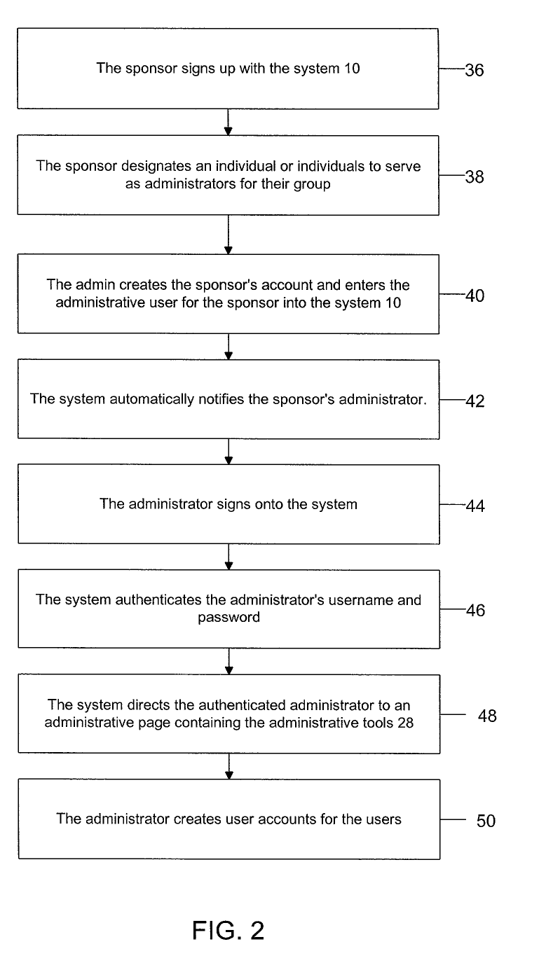

As shown in FIG. 2, first, a sponsor (such as Financial Advisory Company) signs up with the system 10 (step 36). Typically, sponsor initiation occurs by contacting the system administrators at the host office, providing address and contact information, an image or logo, and so on. The image or logo of Financial Advisory Company appears in the upper left corner of every page of its advisors and its clients. Finally, the Financial Advisory Company designates an individual or individuals to serve as administrators for their group (step 38).

Once Financial Advisory Company's account is created and the administrative user is entered into the system 10 (step 40), the designated administrator is contacted by the system (via e-mail, electronic page, and so on) (step 42). The administrator then signs onto the system by typing a user name and password that was created by Financial Advisory Company during the sign up (step 44). The system authenticates the username and password (46), and directs the authenticated user to an administrative page (step 48), which contains the administrative tools 28. Using the administrative web page, the administrator creates user accounts for the users (step 50), including a username, password, password hint, notification information (such as e-mail address, pager, and so on) for notifying the user regarding pending messages, tasks, and changes to the system. Additionally, the administrator can upload a digital photo, letterhead logo, and other information for use with various features. Finally, for use with the Account module, which is described in detail later in this application, the administrator enters birth date information for the user and enters text names for each of the user's financial accounts. Both advisor accounts and client accounts are created in the same manner.

Generally, the administrator has access to the user account meta-data for his or her organization, allowing the administrator to add users, edit user information, modify account information and so on. Users are categorized as advisors or clients based on the relationships they have with other users on the network. Each user may be an advisor, a client, or both, depending on assigned relationships.

### 2b. Relationships Within the Collaboration System

Within the system 10, a relationship is established by defining a user-based association between a pair of users 20. Each relationship is unique as to that pair of individuals. In other words, an user, who is defined in the system as an advisor to a second user, is not thereby also categorized as an advisor relative to other users in the system 10. Thus, each relationship defines a unique association between two users, and additional relationships are required to extend a similar association to other users for each such association.

Associations or relationships between users essentially define the network, or more specifically, relationships within the system define “networks” or teams of individual users, allowing secure communication and exchange of confidential information over the system 10 between team members.

Generally, relationships are assigned to a user relative to only one other user, such that a first user is a client, an advisor, or a peer to a second user. The first user is a client, an advisor, or a peer to a third user, and so on. Each user account may have numerous assigned relationships relative to other users on the system 10, and a user may be an advisor to one user and a client to a second user.

Unlike traditional networks where users are assigned user levels or permissions relative to the network, in the present invention, user permissions are assigned as relationships relative to each other user, individually. Thus, the interconnected user relationships form networks of people (users) for exchanging information and working together. The system 10 allows these people to build their own networks of people across corporate and geographic boundaries, to extend the efficiencies of corporate computer networks to include people (clients, advisors, associates, and so on) who otherwise cannot get connected.

Generally, relationships are hierarchical within the system 10, such as advisor, assistant, client, and so on. Typically, users are categorized in each relationship with respect to this hierarchy, such as client/advisor, doctor/patient, and so on. Advisor to advisor (peer-to-peer) relationships are also possible. Other types of relationships may be desirable depending on the specific application, and such additional types of relationships can be added easily within the system 10.

Finally, relationships define teams of users. Each user may belong to multiple teams, and each user may play different roles within different teams. The system 10 does not define the teams, nor does the system fit everyone into a single team or network. Instead, the system 10 networks people together regardless of where they work or where they live, allowing users to build their own networks of users with whom they work.

To illustrate the flexibility of the system 10, FIG. 3 illustrates two overlapping teams of users sponsored by the Financial Advisory Company. The Broker is shared between the two teams; however, the Broker needs only a single log in to access information relative to the two teams. Without creating any additional system connections or logins, the Broker can be assigned to both teams. Though the two teams share the Broker, the two teams remain distinct. The shared user does not combine the two teams or destroy their “separateness” on the system. Only the Broker is privy to information relative to both teams.

Ms. Adams' team 52A is formed of users 20 who have a relationship to Ms. Adams through the system 10. Ms. Adams uses the system 10 to collaborate with her team 52A. Ms. Adams' team 52A includes an Insurance Agent 20 and a Broker 20. Similarly, Mr. Jones' team 52B is formed of users 20 (an Accountant, a Lawyer, and the Insurance Agent) who are associated with Mr. Jones' user account in the database. As shown, the two teams 52A,52B share the Broker, and thus have one overlapping user 20.

Each user interacts with the system 10 over the Internet 18. Within the system 10, users 20 are permitted to communicate over the system 10 only if they have an established relationship. The relationship effectively defines the communication channel between two users 20. As shown, the Broker 20 has a defined relationship both with Ms. Adams and with Mr. Jones. The relationships are stored in the broker's user account, such that when the broker logs into the system 10, the broker can communicate and share documents with either Ms. Adams or Mr. Jones.

Generally, the system 10 permits no communication between users without an existing relationship. Messages transmitted within the system (as will be discussed in later sections) are not transmitted over the Internet, but are instead stored locally and shared with the recipient user. Outside e-mails are not admitted to the system 10, and new users are not added to a list of subscribers, so unwanted e-mails or solicitations (sometimes referred to as “spam”) cannot be transmitted to users 20 on the system 10. The system 10 is designed to allow individuals or users 20 to create teams (such as 52A and 52B) or loose-knit virtual groups for distributed collaboration, without inviting unwanted e-mails and without displaying documents publicly on the Internet, and without compromising security for existing networks.

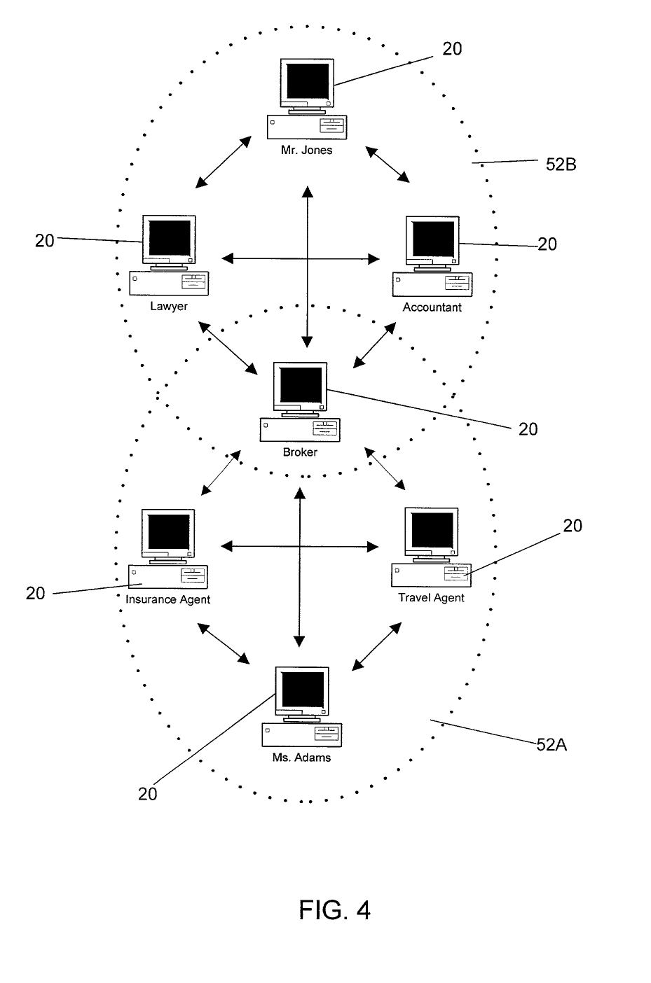

From an administrative perspective, each user account need only be established once. To create associations or relationships between users, the administrator uses the administrative tools to assign a new client or a new advisor relationship to the user account. The corresponding relationship is automatically stored in the associated user's account. In other words, if the administrator assigns a client-to-advisor relationship to a user, linking the client to the advisor, the corresponding advisor-to-client relationship is automatically established in the advisor's account in the system. The administrator assigns the relationship to an existing user simply by clicking on the user's name in a list and adding the association on the admin web page. Thus, maintenance of the system 10 is efficient and simple As shown in FIG. 4, the pairs of relationships in Mr. Jones' team 52B and Ms. Adams' team 52A are shown in greater detail. As shown, the broker is connected to everyone on both teams, while having only one user account in the system. In this example, all of the users on both teams have established relationships permitting two way communication between any and all parties of the team 52A,52B. However, peer-to-peer or advisor-to-advisor relationships are established on a case-by-case basis, with each relationship pair being defined individually, so in some instances, an advisor on the team may not wish to enter a relationship with other advisors on the team.

Since each relationship is defined between two users 20 and since each relationship is established on a case-by-case basis, each user account may have numerous relationships within the system 10. A user 20 may be a client in one relationship and an advisor in another. For simplicity, the varied roles of the individual users 20 are not shown. However, since the roles are defined individually relative to each pair of users 20, it will be readily understood that an the Insurance Agent advisor within Ms. Adams' team 52A may be a client relative to lawyer on the system 10, and so on. Ms. Adams'may herself be an Accountant, who advises other users 20 on the system 10. Each user's role is defined relative to only one other user 20. Thus, the user's role within the system 10 parallels the varied real world relationships of service professionals.

The designation of client and advisor is partially a book-keeping function, and it applies to each individual relationship in the system 10. The designation does not extend beyond a single relationship, though it maybe the same across a number of relationships. Regardless of status within the hierarchy, generally, each user controls access to their own documents. Other users gain access to the user's account only if the user elects to share the document, the account, or other item on the system 10.

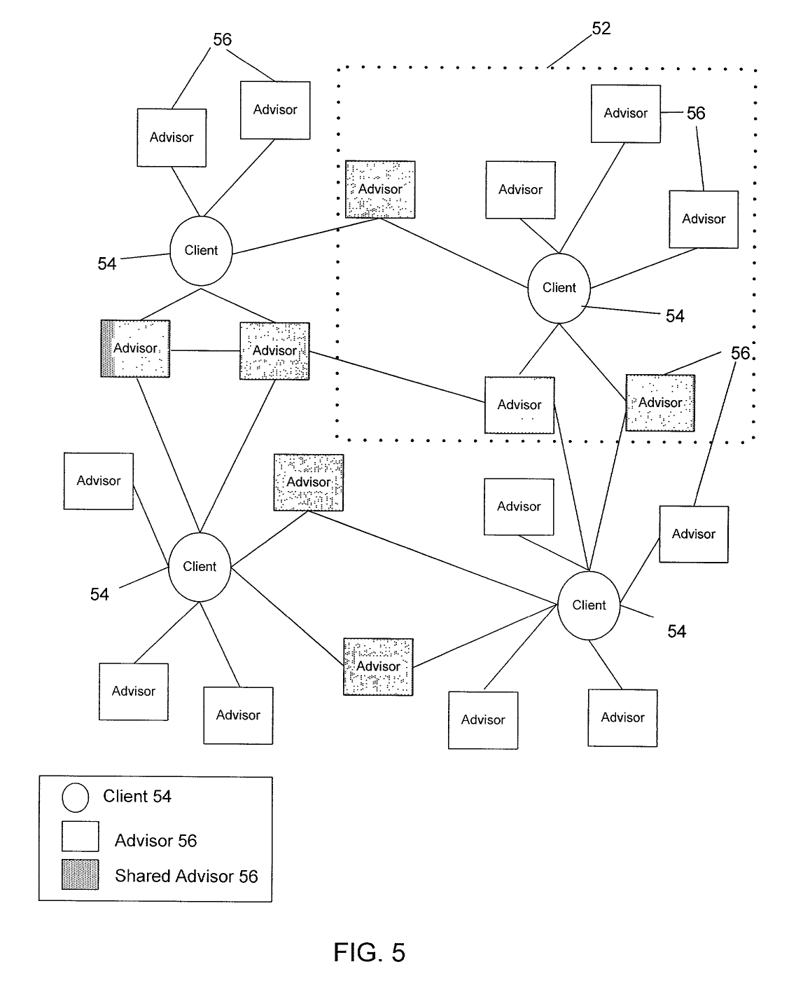

As shown in FIG. 5, within the Financial Advisory Company's user group, the relationships can become quite involved. Some advisors 56 are shared by multiple teams 52, while other advisors 56 have only one client 54 and are not shared. All relationships or connections are elective, meaning that the advisor 56 chooses whether to establish the connection.

Referring again to the Financial Advisory Company example, the firm designates a user as an administrator for the office account. The administrator then uses the administration tools 28 to configure each financial advisor and various support staff members as registered users 20. Some of the financial advisors may want to have the ability to communicate with each other advisor in the office. The administrator establishes peer relationships between the various advisors as requested by those advisors. When one of the advisors wants to add a client, the administrator creates a new user account and defines a relationship between the client account and the advisor user. As previously mentioned, the relationship is added to only one of the user accounts (either the advisor's account or the client's account) in order to create the relationship within the system 10. Finally, the administrator creates a user ID and a password for the client, so that the client can access the system 10 over the Internet. Other advisors do not automatically have a relationship with the client. Each relationship must be configured individually.

Thus, the system 10 allows for a user-by-user association. Additionally, absent a relationship between two users, no direct communication can take place through the system 10 and only the administrator knows that the client is even part of the system 10, until relationships are added.. Thus, the relationship and any related documents can be maintained in absolute confidentiality as between two related users. While each advisor can share documents and/or information with other advisors in the Financial Advisory Company, each decision whether or not to share information is determined on a case by case, document by document, basis by the particular user 20.

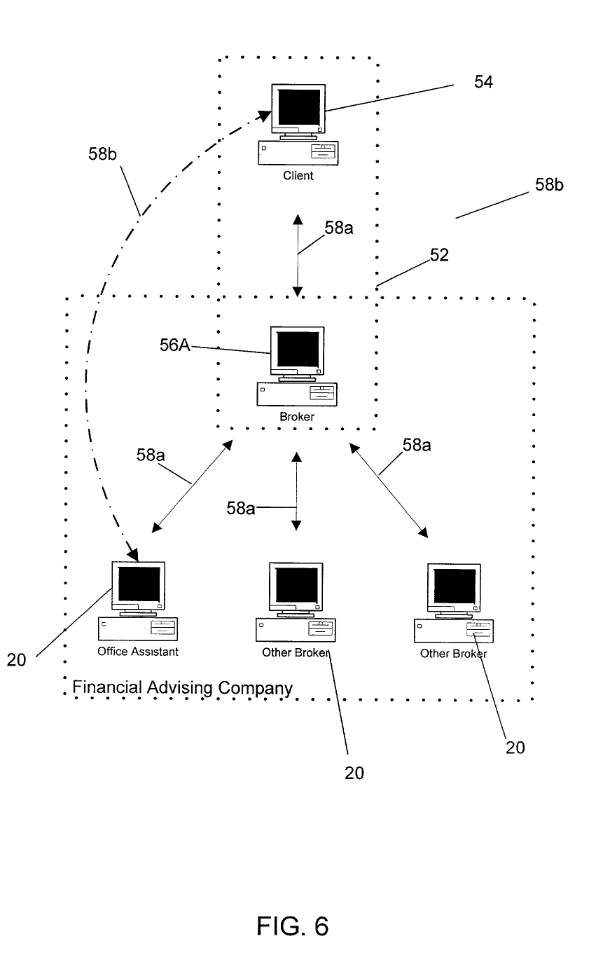

In FIG. 6, the Financial Advisory Company is shown relative to one new client user 54. Once the advisors 56 are entered in the system, the administrator creates a client user account and relates the client user account to one of the existing advisors 56, such as the broker. The resulting relationship or communication path is represented by arrow 58a. As shown, the broker user account 56A has a defined relationship 58A with the client user account 54, allowing the broker 56A to collaborate and share documents via a secure channel over the system 10 with the remote client 54. The broker 56A and the client 54 are a team 52.

Direct relationships between the client user 54 and other users 20 in the Financial Advisory Company's office may be established within the system 10 if desired (shown as dotted lines 58b). As additional relationships are established, the boundary of team 52 extends to encompass those additional related users 20.

FIGS. 3-6 illustrate the interrelation of users 20 in the collaboration system 10; however, numerous other types of advisor relationships are contemplated and are equally valid, such as broker/client, travel agent/client, insurance agent/client, doctor/patient, and so on. Additionally, other types of peer-to-peer relationships may be formed, such as between financial advisors within a brokerage institution, between loan officers at a lending institution, and so on. Once the relationship is established, the user 20 pairs can exchange information securely on the Internet through the system 10.

### 3. Web-Based Tools

The system 10 includes web based tools, both for the administrators and the users, to facilitate system administration and client/advisor collaboration, respectively. As previously discussed, administrators have access to administration tools 28, which are accessible using clickable links or objects on the administrative web page. Similarly, users, whether advisor or clients, have access to productivity tools (or modules), which are accessible using clickable links or objects on the users home page. The user's username and password direct the user to his or her home page, and the Administrator's username and password directs the administrator to the administrative web page for his or her organization.

### 3a. Administration Tools

As previously mentioned, when the administrator logs into the system 10, the server displays the administrative page. The administrative page provides clickable links for the administrator to access specific tools for administering the database and user accounts, and for monitoring usage and so on. Each sponsor or organization has one or more administrators. Thus, there are multiple administrators on the system 10, each has administrative privileges and access only to his or her organization and users associated with that organization.

Adding a new user or editing a user account are both functions offered within the administration tools. User information typically includes a mailing address, an email address, telephone numbers, fax numbers, financial account information (optionally), additional address locations, notification information (which the system uses to automatically generate notices to the user that a message is waiting), and a birth date. On a user's birthday, the system automatically generates messages to all associated users (users who have a relationship with the “birthday” user) notifying the associated users of the special day, to assist advisors in providing better personal service for the client.

The administrative page is accessible over a secure connection on the Internet, and the administration web page provides a set of web-based administration tools that allow the authenticated administrator to add/delete users, update user accounts, update relationships, update sponsor information (such as the logo), administer an on-line referral list or yellow pages, generate reports, upload data to the server, view the data and so on.

Since the administration tools 28 are available over the Internet and provided in a web form, no special software is required to administer and maintain the server. Moreover, the administrator can update account information from anywhere in the world, allowing the administrator to check in and make changes even when he or she is out of town.

Generally, every tool in the administrative page is accessible via a clickable link. For example, to assign a relationship, the administrator clicks either a link to “assign client to advisor” or a link to “assign advisor to client” or a link to “assign advisor to advisor”. Then the administrator selects the name of the advisor and the name of the client and saves the assignment. Similarly, each function or administrative task is performed with a few mouse or pointer clicks.

The administrator configures the Accounts module for each user, who uses the investment accounts module. The Accounts tool allows the administrator to edit, add, and delete investment account information, such as the investment account number, a name for each account, and so on. Since some users have more than one investment account or different investment accounts for each family member, the user can bring each of those investment accounts into the system and provide names to identify each account. The user provides “real names” for each investment account. These names can be a combination of letters and/or numbers, so that each account can be readily identified. Additionally, each account is labeled as either taxable or non-taxable, depending on the investment. For instance, an IRA account would be non-taxable.

The administrator also configures the Recommended List of investments, within the Account module. The recommended list is created by the advisors at the Financial Advisory Company for the purpose of recommending particular investments. Each investment on the list is displayed with the logo, the investment symbol (such as the NASDAQ or the NYSE ticker symbol), sector, sub-sector, growth rate, and other information. Within the display list on both the advisor's and the client's account module web page, the list is clickable so that the user can click on any one of the displayed recommended investments to learn more about that particular investment.

The administrator can view all user accounts, which he or she administers. Specifically, the administrator has access to the user names, last login date and time, and various account statistics, and so on. This level of access allows the administrator to create user accounts, establish relationships between existing users, modify account information, and to generate reports based on account statistics, such as usage and the like.

Additionally, the administrator maintains an on-line yellow pages that can be made available to all users on the system. Essentially, the on-line yellow pages serve as a referral service, to which individual advisors can subscribe so as to market his or her services to other users on the system. Each individual user makes the determination whether to subscribe, independently, and each subscriber is charged for participating

With respect to sponsor information, the administrator can click on a link to update photos and web site addresses. Thus, if a sponsor changes its information for whatever reason, the administrator can quickly and easily update the information.

A “LOG ADMIN” function permits the administrator to check if the automatic investment “quote” server is working properly. The “quote” server accesses and downloads current investment values from the stock exchange periodically, for each investment in the system 10. The downloaded quotes are cached so that even if the connection is lost, the last cached quotes remain available for users on the system 10. The last cached quotes contain relevant information, since the quote server updates every few minutes. By caching the quotes, the speed of the system is enhanced because viewing account information does not require retrieval of the real-time value of the investment. The downloaded quotes are used by one of the productivity tools 32 (the Account tool) to calculate the value and performance of investments for advisors on the system.

Additionally, the administrative tools 28 provide an interface for the administrator to upload investment accounts information, which is typically downloaded daily from the remote investment brokerage database. In this case, the administrator at the Financial Advisory Company downloads the investment account information for each client from a prime broker's database and imports the data into the Financial Advisory Company's database. The administrator reconciles the data with cost basis, splits and so on, and then exports the data from the software. Finally, the administrator uploads the reconciled data to the system 10. Typically, the uploaded data includes an account number, purchase date, symbol, description, quantity, cost, current value, maturity date, asset class, sector and sub-sector (if available) and so on, for each investment. Finally, a data administration link allows the administrator to view the uploaded investment account information to make sure that it uploaded correctly into the system 10.

The administration tools allow the administrator to access, modify and maintain the database information for his or her organization. Additional or different functionality is provided depending on the needs of the organization. For example, a doctor's office may not need the “centerpiece” function, so it would not appear in their administration page. Other tools such as “Generate Billing Report”, and so on, would be available instead. Generally, all administration tools 28 are provided in the administrative web page and are accessible using a web browser.

### 3b. Productivity (User) Tools

Continuing with the Financial Advisory Company example, the following discussion illustrates the functionality available to both the investor (client) and the financial advisor in the present system. Generally, clients and advisors within the system share the same basic tool sets, which provide essentially the same functionality to both the advisor and the client. However, the client functionality is limited to the client's information, whereas the advisor's functionality extends to all of his or her clients at once. The following discussion uses the generic term “user” to refer to any user in the system 10 other than the administrator.

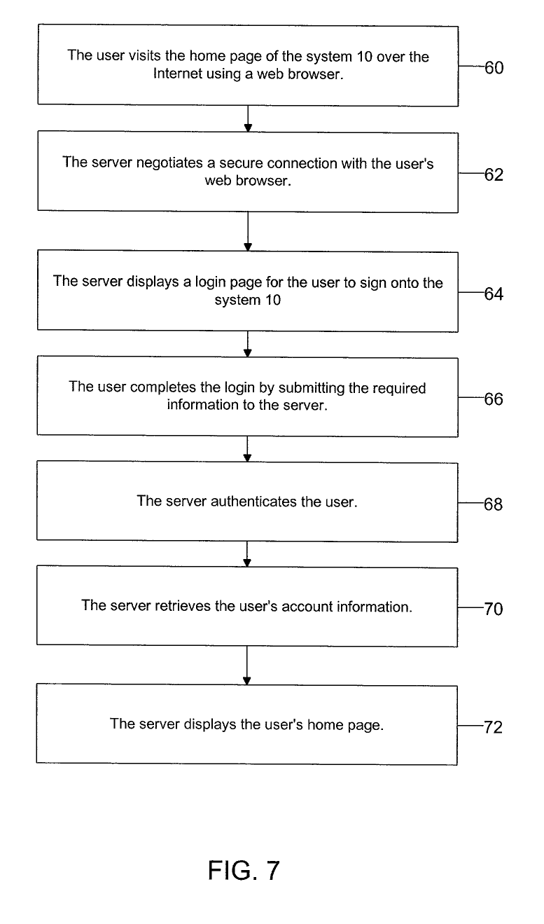

From a user's perspective, as shown in FIG. 7, the user visits the Financial Advisory Company's sign in page over the Internet using a web browser, such as Microsoft Internet Explorer, Netscape, and the like. (step 60). The server negotiates a secure connection with the user's web browser (step 62), and displays a login page for the user to sign onto the system 10 (step 64). The user completes the login by submitting the required information to the server (step 66). The server authenticates the user (step 68), retrieves the user's account information (step 70), and displays the user's home page (step 72).

The user's home page is organized to provide easy access to useful information. For example, the first item on the menu bar is the “team” menu. Clicking on the Team menu button causes the server to display a “team” page, containing a clickable list of all the advisors on the user's team. Typically, each advisor is displayed as a business card with a picture of the advisor, and clicking on a business card causes the system to retrieve and display contact information for that advisor, such as a telephone number, mailing address, and the like. Additionally, from the on-line business card, the user can click on a “file” button (to view all files posted to the user from that advisor), a “mail” button (to send an instant message to that advisor), and a “task” button (to view all tasks assigned to the client by that advisor or to assign a new task to the advisor).

Other items on the menu bar include “Clients” (if the user has any), “Accounts,” “Messages,” “Documents,” “Tasks,” “Links,” and so on. Each menu item is a clickable link, which opens a new window to display the information associated with that item. If the user has clients, the “Clients” link opens a page containing a clickable list of clients. If the user has messages waiting, the Messages menu item displays the number of messages in parenthesis, and opens a new page to display the waiting messages when clicked. If the user has documents posted to the system 10, the Documents menu displays the number of documents in parenthesis. When the user clicks the Documents menu, the server retrieves and displays a list of posted documents to which the user has access. The user can post new tasks and associate them with an advisor or a client, view tasks and so on. The Links menu item leads to a page of useful Internet links.

Each of these menu items can be considered a productivity module, in the sense that each menu item makes a different set of tools available to the user. Additional tool sets or modules are anticipated, and can be added to the existing user accounts at any time simply by adding server pages for those tool sets and by adding a menu item to the menu bar. More importantly, from the user's perspective, the addition of such modules is transparent, because the user need only refresh his or her browser window to have access to the new functionality.

Additionally, clicking on any menu item automatically opens a new window sized to cover the menu on the home page. When the user is finished interacting with the window, the user can close it and immediately return to his or her home page. Thus, each view screen covers the previous screen to eliminate confusion and to minimize server communications, because returning to the previous screen does not require server interactions.

The client's link displays a list of clients for that particular user. The list can be sorted by name (first or last) and by last login (in ascending or descending order), simply by clicking on the heading above one or the other of those items in the list. Each name in the list is also clickable, to pull up that client's contact information, picture and so on.

Within the system 10, user information is entered only once, and any updates automatically extend to every other related user. Thus, if an advisor updates his or her contact information, the information is updated in every client's “business card” list under the “TEAM” menu. Since the information is retrieved from the server each time the user clicks on the advisor's business card, updating the contact information in the system automatically updates the contact information for everyone else.

### The Documents Module

The Documents menu item directs the user to a documents page, which contains all uploaded documents in the user's account. The user can upload documents by clicking the “upload document” button. Once the document is uploaded (or at the same time that the document is being uploaded), the user can share the document with any of the user's advisors or clients by clicking a button and selecting the particular user.

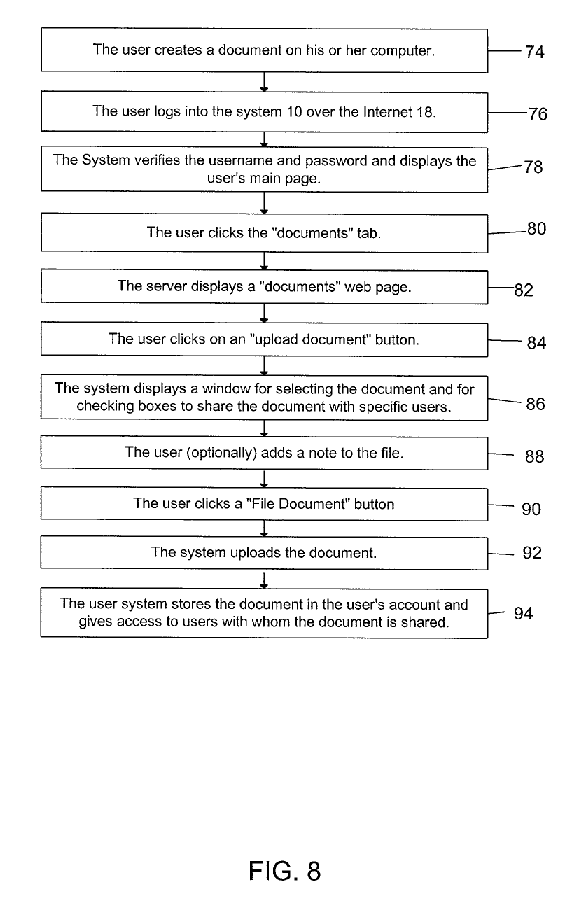

As shown in FIG. 8, to share a document, a user 20 creates a file (step 74) using a word processor, a sound editor, or some other program on his or her computer. Next, the user 20 logs into the system 10 over the Internet 18 (step 76). The system 10 verifies the username and password, and displays the user's main page (step 78), containing links to the productivity tools 32. Next, the user 20 clicks on the “documents” tab (step 80), which accesses the document module. The server 12 displays a document page (step 82), which contains a list of all posted documents available to the user 20. Next, the user 20 clicks on an “UPLOAD” button or link (step 84), which opens a window allowing the user 20 to select the file on his or her local computer or local network. The window also provides check boxes allowing the user 20 to immediately share the file (step 86) with other “related” users 20. Optionally, the user adds a note or description to the file (step 88) for on-line viewers to read the description before viewing the file. Finally, the user 20 clicks a “File Document” button (step 90) to file the document with the system 10. The system 10 uploads the document (step 92), and stores the document in the database. Finally, the system 10 relates the file to the user's account (essentially storing the document in the user's account as a related record in the database), and gives access rights to users with whom the user has shared (step 94).

The note feature allows the user 20 to briefly describe the contents of a file. The note may be added during the upload process or at any time afterward by the owner of the document. If the note feature is used, a “note” link appears next to the file name in the list, together with the actions that a user 20 may perform on the file.

When a user shares a document, the system 10 simply gives the related user access to the document. The document is not duplicated in the system. Thus, memory in the database is conserved, and multiple copies of the document are not stored in multiple places. The owner of the document can remove the original of the document simply by clicking a “delete” link, and all shared copies of the document are deleted at the same time with the same action. Nevertheless, sharing a file is transparent to the user, such that from the user's perspective, he or she has her own copy of the file.

The owner of the file is permitted by the system 10 to update, copy (share), delete, move or add notes to the file. The move feature permits the user 20 to move the document from the “in-box” to another subdirectory. Standard subdirectories, which are automatically created for each new user account, include in-box, insurance, investments, legal, medical, other (miscellaneous), and taxes. The “category maintenance” link permits the user 20 to add and name additional subdirectories, which are then added to the list in alphabetical order so that the user can customize his or her document's page.

When the owner shares the document with another user 20, the shared document is in “read only” format for the other user 20, because the other user is given permission to access the document stored in the owner's account. The other user 20 may view the document on the server. Any changes made to the document must be saved in a different file, and may be posted by the other user 20. Additionally, if the other user 20 deletes the “read only” file, the shared file is deleted from his or her user 20 account, but the file remains in the owner's user account. By contrast, if the owner deletes the file, the file is deleted for the owner and for all of the shared users 20.

Files posted to the server cannot be downloaded directly. Within standard web browsers, clicking the right mouse button allows the user to download the file; however, in the present invention, such downloads are not permitted. Thus, a user could distribute an encryption program to another user and exchange files over the system to add an additional layer of protection.

Within the system 10, the document is not duplicated in the database. Instead, when a document is posted, the database indexes the file using a unique file identifier (such as a serial number) and links the file to the owner by the owner's unique identifier. The unique file identifier is used by the relational database to retrieve the file upon demand. When the file is shared, the unique file identifier is copied to the other user's account. The unique file identifier acts as a pointer to the location of the actual file in the database..

The system 10 provides a secure environment for document exchange so that the service provider can upload documents which the client can then access and print out locally without risking email security breaches or other types of document security problems. The client can then amend or change the document contents and upload the amended document for the review. Thus, the system 10 maintains electronic versions of documents through the iterative revision process, allowing both users 20 to look back at earlier drafts.

### The Accounts Module

Within the Financial Advisory Company, the Accounts module provides the greatest benefit to both the client and the financial advisor. Because of the user-to-user relationships of the system, the client can choose to add another advisor to his or her account, such as an Accountant, who is not affiliated with the Financial Advisory Company. Then, once the client/advisor relationship is established with the accountant, the client can share his or her accounts with the accountant.

Once the accounts are shared, the financial advisor, the accountant and the client can work together to withdraw cash from investments according to the best tax benefits, and so on. Essentially, the system 10 allows the client to expand his or her team to include a user, who may have much to contribute to the decision-making process, but who otherwise would be unable to view the account information for that client.

In the Financial Advisory Company, both clients and advisors desire quick access to investment account information. As previously described, each day, the administrator downloads the current investment account information for each client from the prime broker's database, reconciles the information and uploads it to the system 10. Once the data is in the system 10, the advisor can view all of the investment account information for all of his or her client's at once in a single page. The information is displayed inside of a web page in a list that can be sorted by the advisor by clicking on the list headings, such as account name, symbol, name of investment, last value, day percent change, growth parameter, price-to-earning ratio, yield score, amount up, and so on. The accounts module provides a powerful tool for analyzing the investment portfolio “at a glance”, because it allows the advisor to view all of the investments for all of his or her clients on a single page, all at once.

Generally, the accounts module processes the retrieved data to generate a score based on the real-time value of the investment as compared with a “fictional” baseline value. The fictional baseline value is the calculated dollar value of the investment based on the original purchase price, assuming an annual percentage rate of growth per annum (according to the growth parameter entered by the administrator), prorated to the current day. The module uses the fictional baseline to evaluate the current value of each investment and to assign a score to the investment according to its actual performance relative to the fictional baseline.

The investments are then sorted according to the calculated score and displayed in an account page. The score provides an “at a glance” analysis of the performance of the investments relative to the 10 percent growth target. Investments scoring below the fictional baseline appear as negative numbers, whereas investments appearing above the baseline appear as positive numbers. The higher the number, the further the investment's performance is from the fictional baseline. Thus, a score of plus 10 would indicate a growth rate far exceeding the 10 percent baseline.

From an advisor's perspective, the investments for all of his clients can be viewed at once on a single page. The advisor can sort the list according to the score and find investments that are doing exceptionally well, as well as those that are doing poorly, and assist the client in making investment adjustments to his or her portfolio. Each investment is displayed individually in the list, and clicking on the investment opens the e-mail form addressed to the client-owner of that particular investment, so that the advisor can quickly communicate investment advice to the client, without switching between windows or between applications. Moreover, the advisor can view investments for all of his or her clients at one time, without having to separately access each of his or her client's accounts.

For both the advisor and the client, the accounts module provides a link to the Financial Advisory Company's recommended list. The recommended list includes the price/earnings ratio, as well as a PE/earnings growth rate calculation for breaking down the recommended investment “at a glance.” Each item in the recommended list is clickable to open a page providing the investment's “report card” for the user's review. The report card includes the advisor's investment analysis. The recommended list provides a useful financial tool for both the client and the investor, both for discussing investment opportunities and for analyzing the existing investment portfolio of the client.

Of course, this discussion assumes that the client has chosen to share the “account” file with the financial advisor in the system 10. Once shared, the advisor can view the shared accounts and their scores, and use the scores to provide investment advice to the client in real time. The system 10 automatically updates the real value of the various investments periodically using the “quote” server. The real value is then cached so that quote information is available even if the “quote” server connection fails. Additionally, because the account module uses cached values, the advisor gains the additional benefit of speed. Specifically, the advisor loads the investment list from the database and views the list with the cached values. The entire delay is between request and display falls on the system, which is much quicker than retrieving real time values for each investment from the various stock exchanges each time the list is viewed. Thus, the productivity tools 32 provide powerful processing tools for professionals to quickly analyze and provide valuable advice to the client in short order.

Generally, the percentage rate of growth is a 10 percent baseline, which provides a growth baseline that is higher than the stock market average over the past 50 years (approximately 7% per year growth). However, the 10 percent baseline is arbitrary. The percentage could be set higher or lower by the administrator, and the scoring system 10 would simply use the new percentage.

The accounts page displays for the advisor the investments of all clients who have shared their account information. The advisor can quickly view all investment listings for every client, sort the list according to any of the account parameters and so on. The same tools are available to the client with accounts in the system 10; however, the investment list is limited to the user.

When the advisor has multiple clients, the account's system displays each of the client account names in a list along the left side of the web page. Each client name has a check box next to it. The advisor can click multiple accounts and generate reports such as “Today's results”, “Overall” and so on. The check boxes allow the advisor to limit the report display as needed. Additionally, the advisor can view non-taxable accounts only and so on. The same view list with the scoring feature is applied to each of these account displays, but the number and type of accounts shown can be selectively reduced at any time by choosing specific accounts or limiting the parameters.

For an individual client, if he or she has multiple investment accounts (such as a family having a joint account, an education IRA, and so on), each of these accounts are viewable from a single page, and clicking on any of the accounts displays more specific information about the account. Additionally, clicking on the investment immediately opens an e-mail form already addressed to the broker. Thus, communication between the investor and the advisor does not require the user to switch between programs, to go to different windows and so on. The entire communication between the advisor and the client is automated wherever possible.

Additionally, the accounts page provides a number of report functions for analyzing client investments, such as “Today's performance” (displays the day's performance of each selected investment), “Overall” (displays the performance of each selected investment since it was acquired), a “Trader” report (displays the performance according to the scoring calculation discussed above), the “Sector” report (displays the various investments according to economic sector and sub-sector), and so on. Generally, the account data includes the cost basis for the particular investment, so the analysis is performed and displayed against the correct cost basis. Additionally, data is stored in the server as raw data, so that calculations are performed on the raw data using the most recent value information. The administrator can add additional reports, which then become available when the user refreshes his or her browser window.

When viewing an investment in the list, the client's name appears next to each investment, so the advisor can click on the client's name and instantly send a message to the client regarding their investment.

Additional functionality within the Account module is also anticipated, such as on-line trading (as in stocks, and so on), as well as chat capabilities, so that the investor can chat with his or her advisor in real time.

### The Messages Module

The user's main page also contains a link to the Messages Tool. Unlike traditional e-mail, the messages are stored in the database, and are not transmitted over the Internet as e-mail messages. A user imply clicks on the “send new message” button, fills out the e-mail form, selects the recipient, and “sends” the message. However, the message is not sent. Instead, the message is stored in the database and shared with the recipient. Additionally, the recipient is notified automatically by the system that a message is waiting (either via a pager, e-mail notification, a message to a mobile device, or similar means).

The messages module displays “new”, “received” and “sent” folders for easily accessing the mail through the web browser. Additionally, a custom logo appears on the e-mail, so that the e-mail looks like it is written on company letterhead.

The messages module also provides a simple reply feature, which provides the reply message area right below the text of the received message. The user can then fill out the reply message, which is already pre-addressed to respond to the original sender, and send the reply. No additional button clicks and no switching between windows is required. Thus, the user's time is not wasted switching between applications.

Since user's access all pages on the server using SSL connections, transactions are secure. Since the messages are posted and shared using the same secure connections, the transmission is secure in the system 10, unlike traditional e-mail. More importantly, the messages are accessible using a web browser, and no additional software is required for the electronic transmission of secure messages.

Finally, each time a message is sent within the system, the system 10 automatically generates a notification message to the recipient. The notification message is transmitted by a page directed to a pager, via e-mail to a traditional e-mail account, and so on. The type of notification is determined by the particular user and entered by the administrator during account set up. Thus, messages are not simply posted within the system without notifying the recipient that a message is waiting.

### The Task Module

The Task menu item allows users to post tasks for one another, to track progress of those tasks, and to reassign tasks. Such tasks can be sorted using clickable links in the page. A single click on any task item opens a window containing details regarding the particular task. The tasks are kept up to date by the individual user, and the assignor of the task can access the task to determine when it is complete. Finally, if the task is reassigned, the task is deleted from the user the user to which it was originally assigned. Thus, the task menu adds an additional productivity tool to the user account.

Unlike traditional network configurations, relationships within the system 10 are defined relative to each other user 20. These relationship pairs define the hierarchical relationship between two users 20 for invoice purposes. Additionally, each relationship defines a communication channel between two users 20, which otherwise does not exist in the system 10. The communication channel can be used by the pair of users 20 to collaborate or to provide/receive professional services in a secure virtual environment.

Messages are stored securely within the database. The message is not transmitted as e-mail external to the system. Only a notification is transmitted external to the system. Thus, the system 10 provides a distributed, virtual collaboration environment that extends beyond the boundaries of traditional office networks and on-line services, extending the office network to encompass geographically and systemically diverse users 20.

Other modules or features are also available, such as on-line chat capabilities, on-line video conferencing capabilities, on-line trading, and the like. Each of these functions are provided through various private software means, though they are not integrated in a single professional service provider system. Additionally, though the examples have been provided with respect to a Financial Advisory Company, it will be readily apparent that the invention of extending network efficiencies to users who are outside of the network using the system of the present invention applies to other service industries as well.

Although the present invention has been described with reference to preferred embodiments, workers skilled in the art will recognize that changes may be made in form and detail without departing from the spirit and scope of the invention.

1. A system for facilitating team work between people using web-enabled devices on a secure network, each person having a user account with a user name and a password in a database, each person having an assigned relationship with one or more other persons in the database, each assigned relationship being defined between a pair of users, the system comprising:
the database for hosting all communication between people on the secure network; and
a web-interface for people using web-enabled devices to upload information to the database and to share the uploaded information with other people according to the assigned relationship;
wherein the assigned relationship must be established between the pair of users prior to any communication between the pair of users is permitted by the database.

2. The system of claim 1, wherein each assigned relationship is hierarchical.

3. The system of claim 1, further comprising:
productivity tools for interfacing with the database, each productivity tool being accessible from a web page.

4. The system of claim 1, further comprising:
a quote server interface for interacting periodically with a quote server, for retrieving financial information from the quote server, and for storing the retrieved financial information in the database.

5. The system of claim 4, further comprising:
an account module for displaying financial investment information, the financial investment information including:
investment account information relative to the user accounts, the investment information including a cost basis; and
evaluation data related to the investment account information, the evaluation data being calculated from the investment account information using the retrieved financial information.

6. The system of claim 1, wherein each person has more than one assigned relationship in the database.

7. The system of claim 1, wherein the database is used in a corporate network having more than one server, the database for providing a secure collaborative environment within a corporation over a corporate intranet.

8. A system for facilitating team work between people using web-enabled devices on a secure network, each person having a user account with a user name and a password in a database, each person having an assigned relationship with one or more other persons in the database, each assigned relationship being defined between a first user and a second user, the system comprising:
the database for hosting all communication between people on the secure network; and
a user interface for providing web-based access for the first user to contact information relative to the second user, the contact information being displayed within a web page as an electronic business card, the electronic business card being clickable to directly access the contact information for the second user.

9. The system of claim 8, wherein each user may have more than one assigned relationship stored in the database, and wherein the contact information for each other user of each relationship pair is displayed in a web page as an electronic business card.

10. The system of claim 8, wherein the electronic business card comprises:
a digital photograph of the other user;
contact information for the other user; and
a message button for the other user, the message button being clickable for opening an already addressed message form to facilitate communication between the first user and each other user.

11. The system of claim 10, wherein the electronic business card further comprises:
a file button for the other user, the file button being clickable for opening a web page displaying a clickable list of all files shared by the other user with the first user.

12. The system of claim 10, wherein the electronic business card further comprises:
a task button for the other user, the task button being clickable for opening a web page for the first user to post new task items for the other user to complete.

13. The system of claim 8, wherein the database is accessible from any web-enabled device.

14. A system for facilitating team work between people using web-enabled devices on a secure network, each person having a user account in a database on the secure network, each person having an assigned relationship with one or more other persons in the database, each assigned relationship being defined between a pair of users, wherein the assigned relationship defines each user of the pair of users as either a client or an advisor, the advisor having more than one client, the system comprising:
the database for hosting all communication between clients and the advisor on the secure network; and
a web-interface for each client to share financial information with the advisor, the web-interface providing an interface for each client and for the advisor to view financial investment information relative to each client;
wherein the web-interface displays for the advisor the financial information for each client of the advisor all at once in a single web page.

15. The system of claim 14, wherein the web-interface further comprises:
a scoring script for calculating a score relative to each investment for each client, the score being a numeric value related to change in value of each investment over time as compared with an expected value calculated using a purchase price for the financial investment and an estimated annual growth rate percentage.

16. The system of claim 15, wherein the estimated annual growth rate percentage is 10 percent.

17. The system of claim 15, wherein the estimated annual growth rate percentage is prorated to an estimated daily percentage.

18. The system of claim 14, wherein the financial information is displayed in a list, the financial information comprises:
investment account information relative to the user accounts, the investment information including each investment in an investment portfolio of each client, each investment including a cost basis for the investment; and
evaluation data related to the investment account information, the evaluation data being calculated from the investment account information using a retrieved actual value for each investment in the investment portfolio.

19. The system of claim 18, wherein the retrieved actual value for each investment in the investment portfolio comprises:
a value downloaded periodically from a quote server, the value being cached so that the value for each investment is available even if the quote server is not functioning.

20. The system of claim 18, wherein the list is sortable by the advisor clicking a button on the web interface, and wherein each investment in the portfolio is a clickable item, the clickable item for opening a message form already addressed to the client when clicked on by the advisor.
